(19) United States
(12) Patent Application Publication
(10) Pub. No.: US 2016/0108576 A1
(43) Pub. Date: Apr. 21, 2016

(54) Heavy Duty Suit Dryer

(71) Applicant: Tomer Levy, Sicklerville, NJ (US)

(72) Inventor: Tomer Levy, Sicklerville, NJ (US)

(21) Appl. No.: 14/638,253

(22) Filed: Mar. 4, 2015

Related U.S. Application Data
(60) Provisional application No. 61/996,232, filed on Oct. 20, 2014.

(51) Int. Cl. D06F 59/02; F26B 9/00; F26B 21/00; A47G 25/20

(52) U.S. Cl. CPC D06F 59/02; A47G 25/20; F26B 9/003; F26B 21/008

(57) ABSTRACT

This is a hanger/drying unit that dries leather suits, race suits, wetsuits, dry suits, Hazmat suits, firemen gear, etc, in a much quicker time then air drying. This unit uses a high powerful fan to bring in air and forces it out through the outlets of the arms, chest and bottom of unit. The air is forced through the suit to dry it at a faster rate and help prevent mold, and mildew growth.

This application claims the benefit of provisional application No. 61/996,232 filed Oct. 20, 2014.

This Hanger/drying unit can hold any racing suit, wetsuit, dry suit, Hazmat suits, firemen gear, etc. without altering or damaging the gear. It is designed to force air throughout the race suits or gear to dry it at a faster rate then air dry. The high powerful fan pulls air in from the top of the unit and forces it through the opening at the arms, chest, and bottom of the unit. (see images FIG. 1 and FIG. 2). The forced air opens up the suit and gear to be dried with no creases due to use. There is a strong hook to hold the unit and gear weight with no strain. The unit also has a handle for easy carrying ability.

The air that is being forced through the suit is room temperature and dries the suit or gear in minutes rather then several hours or even days depending on saturation. With this in mind racers, divers, fireman, Hazmat suits etc. are able to use their race suits, wetsuits, dry suits, or firemen gear quicker and feel safer in getting in and out of them without the sticky feeling. The Hanger/dryer unit also helps prevent the growth of mold or mildew due to moisture. While waiting for a race suit, wetsuit, dry suit, Hazmat suits, firemen Gear to air dry the gear can start growing mold, or other bacterial which can be harmful to a person.

### SUMMARY OF THE INVENTION

Most suits and gear will hold moisture which can grow mold and bacteria if not dried and treated properly. Air drying is the main way of drying these items which takes a long period of time. The main purpose of this invention is to dry any race suit, wetsuit, dry suit, Hazmat suits, firemen gear, etc. at an accelerated rate than air drying without altering or damaging the gear after each use. With drying the suits and gear at a faster rate it allows ease and comfort ability for reuse. The Hanger/drying unit will help prevent the growth of mold mildew or other bacterial which can be harmful to a person. This unit has a heavy duty fan that is built in to pull air from the top of the unit and forces it through the openings at the arms, chest, and bottom of the unit to allow full air flow through suit/gear.

The Tubular structure is designed to distribute the weight of the suit/gear over a broad surface. The broad surface opens up the suit/gear cavity, which promotes the air flow for the drying process.

### BRIEF DESCRIPTION OF THE DRAWINGS

FIG. 1 is a perspective view of the Heavy Duty Suit Dryer and all its components without the suit/gear.

FIG. 2 is the bottom and side perspective view of the Heavy Duty Suit Dryer

FIG. 3 is a cutaway perspective view of the Heavy Duty Suit Dryer unit that illustrates the interior components and the airflow pattern when in use.

FIG. 4 is a front view of the Heavy Duty Suit Dryer unit in use with a full body suit in the drying process.

### DETAILED DESCRIPTION OF REFERRED EMBODIMENTS

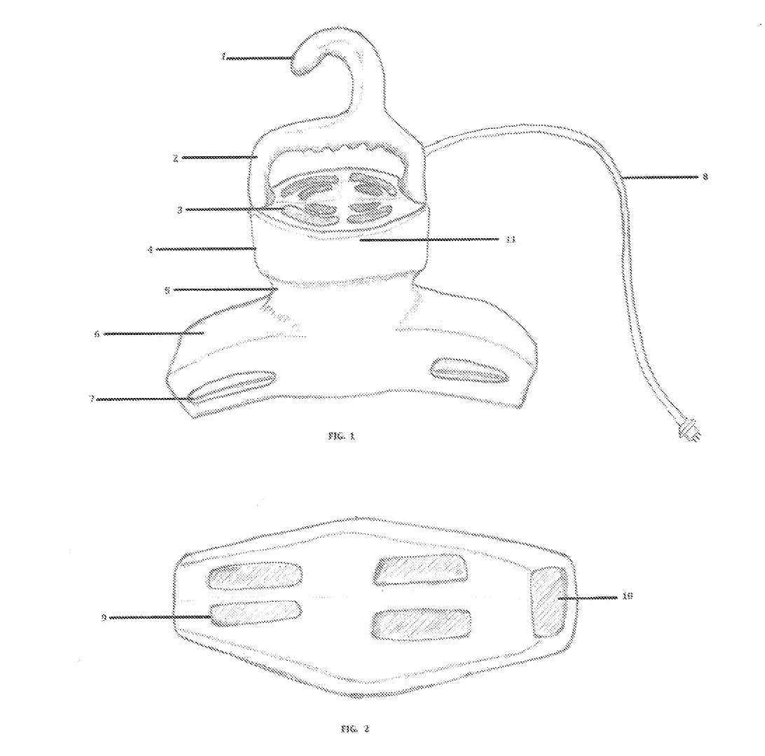

FIG. 1 is a perspective view of the Heavy duty suit dryer that shows all components of the unit. The hook 1 allows for suit/gear to be hung from a pole or a wall bracket or can also be hung by the handle 2. The Handle 2 gives a more comfortable way for transportation of the suit or gear. The fan housing 4 is contained under the handle holds the fan 11 to pull air in through the slot 3 to force room temperature air through the neck 5 of the unit to the tubular arms 6 and out through slots 7 and 10. The tubular arms 6 give a broad surface to minimize stress on the suit/gear when hanging on the unit. The unit is powered by a power cord 8 located in the handle 2.

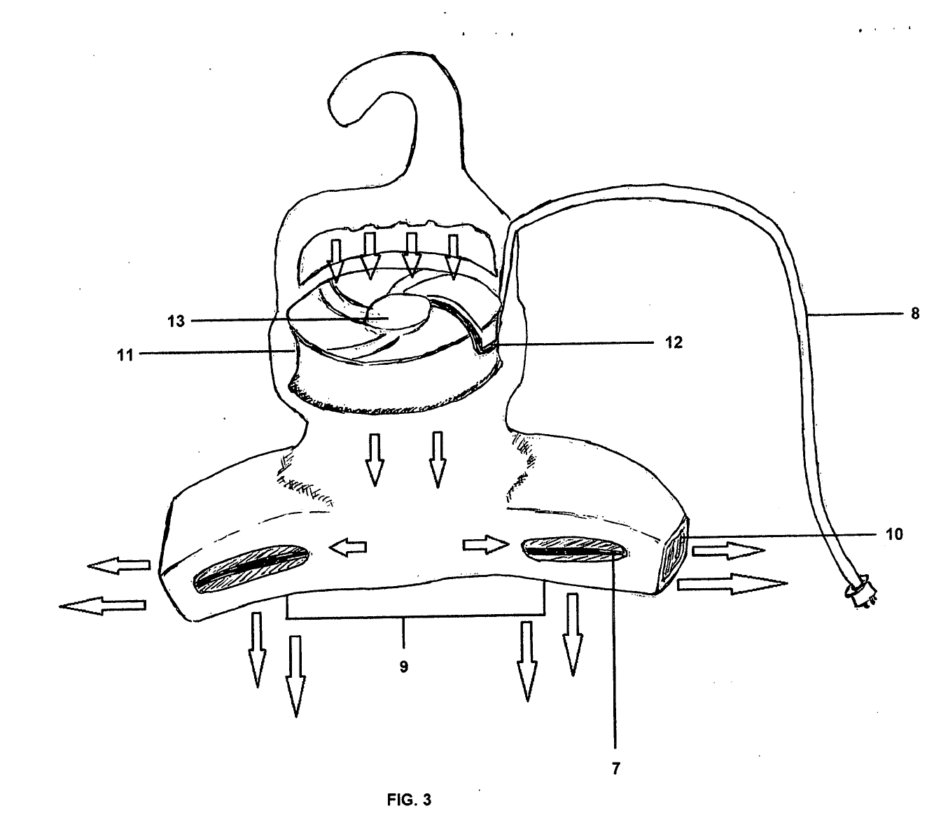

FIG. 2 is the bottom and side view of the Heavy Duty Suit Dryer. When unit is in use the air is forced through the bottom slots 9 and tubular arm 6 slots 10. The open slots 9 force air through the body and legs and out through the ankles of the suit/gear and the slots 10 for air down the arms out through the wrists of the suit/gear when in use.

FIG. 3 is a cutaway perspective view of the Heavy Duty Suit Dryer unit that illustrates the interior components 12, 13, and 14 and the airflow pattern when in use. The fan 11 comes with a strong motor 13 that moves the blades with such power to force the air through the unit to the suit to dry the suit/gear at an accelerated rate. The power cord 8 runs through the handle to for easy access to connect to the power source 12 of the fan 11. When in use the fan 11 draws air in and forces it through the unit and exhausted out the slots 7, 9, and 10. The arrows show the pathway of the air being forced through the unit when in use.

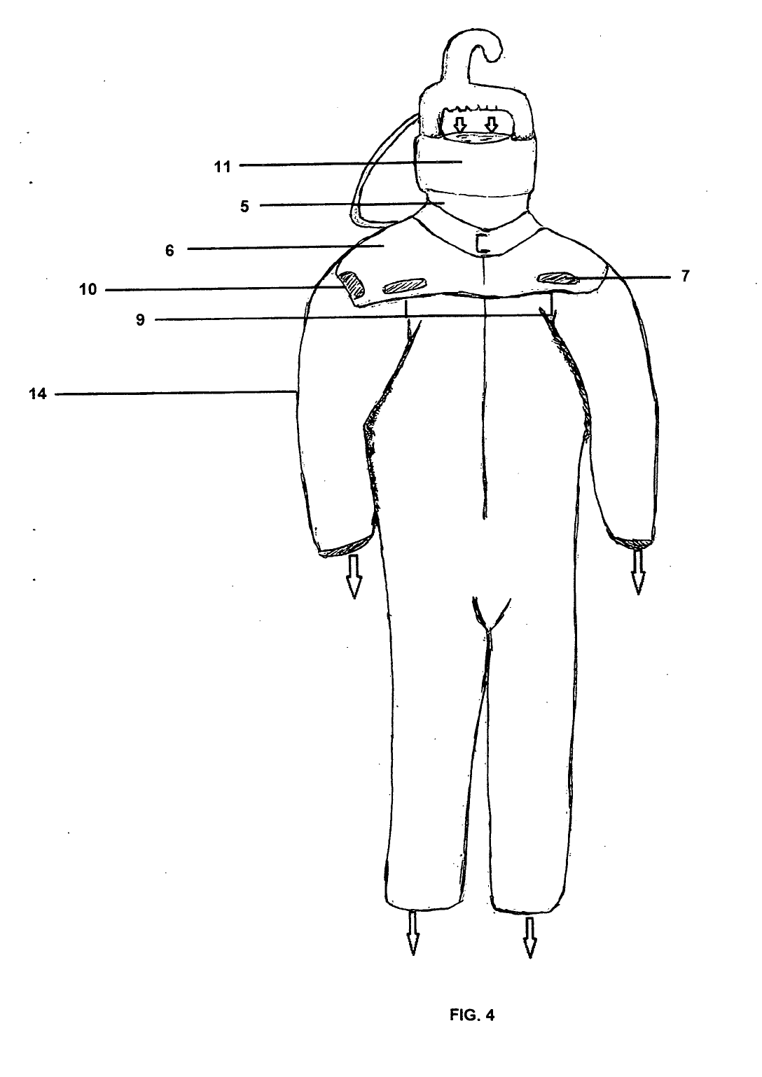

FIG. 4 is a front view of the Heavy Duty Suit Dryer unit in use with a full body suit 14 in the drying process. The Heavy Duty Suit Dryer fan 11 pulls room temperature air in and pushes the air down through the neck 5 of the unit through the tubular arms 6 exhausted out through the vents 7, 9, and 10. The force of the air opens up the suit 14 to avow for acceleration in the drying process. The arrows show the air pathway of the air being pulled in and vented out through the suit 14.

1. A Heavy Duty Suit Dryer unit comprising:
A tubular shape hanger design to support the suit/gear with its broad shoulder design to open up the suit/gear to reduce any stress or damage while being hung during the drying process.

2. A Heavy Duty Suit Dryer unit of claim 1 further comprising an electrical high output motor-driven fan found internally to maximize the strength and force of the room temperature air drawn in to circulate through the unit and expel out through the open slots.

3. A Heavy Duty Suit Dryer unit of claim 1 further comprising of open slots created in the shoulder area, chest and on the underside body of the tubular shape to accelerate the drying process which ventilates into the body and arms and exhausted out through the wrists and ankles of the suit.

4. A Heavy Duty Suit Dryer unit of claim 1 further comprising of a neck configuration found under the fan is designed to provide a sealing surface through the use of the suit/gear own neck opening.

5. A Heavy Duty Suit Dryer unit of claim 2 further comprising the internal fan to be centered above the neck of the unit to maximize the air being drawn in through the top of the unit located under the carrying hook and handle.

6. A Heavy Duty Suit Dryer unit of claim 5 further comprising of a carrying hook, which is found above the internal fan and handle, that can be hung on a pole or bracket while being used or for storage.

7. A Heavy Duty Suit Dryer unit of claim 5 comprising of a handle found under the hook for easy carrying and transportation of the unit while it is holding suit/gear.
